(19) United States
(12) Patent Application Publication
(10) Pub. No.: US 2014/0143248 A1
(43) Pub. Date: May 22, 2014

(54) INTEGRATION TO CENTRAL ANALYTICS SYSTEMS

(71) Applicants: Martin Gembalzyk, Eppelheim (DE); Karl-Peter Nos, Nussloch (DE); Michael Frieben, St Leon Rot (DE); Stefan Girsig, Heidelberg (DE)

(72) Inventors: Martin Gembalzyk, Eppelheim (DE); Karl-Peter Nos, Nussloch (DE); Michael Frieben, St Leon Rot (DE); Stefan Girsig, Heidelberg (DE)

(21) Appl. No.: 13/682,391

(22) Filed: Nov. 20, 2012

(51) Int. Cl. G06F 17/30

(52) U.S. Cl. CPC G06F 17/30705
USPC 707/737

(57) ABSTRACT

Embodiments may provide a system and method for providing aggregated data to a client from a plurality of data sources. The method may include maintaining data in a data repository, maintaining a first analytical view having a first set of metadata including a first set of attributes, and maintaining a second analytical view having a second set of metadata including a second set of attributes. The method may include receiving a request for information, the request specifying the first analytical view and the second analytical view. The information from the data repository in accordance with the first set of metadata and the second set of metadata may be extracted and the extracted information may be analyzed to generate aggregated data in accordance with the first set of metadata and the second set of metadata. The aggregated data may be provided to the client.

### BACKGROUND

Reporting, analysis, and interpretation of analytical data is of central importance to a company in enabling it to make quick decisions. For these tasks, companies use analytical data that is collected from different sources, such as the subsidiaries of the company. Companies can collect the analytical data in a central database. The analytical data from each subsidiary can relate to specific operations of the subsidiary. The company can use the collected analytical data to compile corporate reports to make quick daily decisions.

The analytical data from the subsidiaries can be provided to the database using database tables. The database tables can include the information in rows and columns. However, the database tables fail to include analytical information. For example, the database tables do not include information as to whether the column is a key figure or a characteristic. The database tables also do not include the information about the aggregation and associations to attribute tables.

Some applications use separate entities as data sources that are specifically designed to extract data. However, these separate entities cannot be easily created by users. Furthermore, the entities include complex and time consuming logic, that does not always allow for direct access to the data. These separate entities also do not provide details about data being extracted to the user.

### BRIEF DESCRIPTION OF THE DRAWINGS

The accompanying drawings illustrate embodiments of the present disclosure and, together with the description, further serve to explain the principles of the disclosure and to enable one skilled in the pertinent art to make and use the embodiments of the disclosure.

FIG. 1 is a block diagram of an exemplary database system.

FIG. 2 illustrates an embodiment of a process for accessing analytical data in a database.

FIG. 3 illustrates another embodiment of a method for accessing analytical data in a database.

FIG. 4 is a system block diagram of a system using multiple access layers.

FIG. 5 is a block diagram of an exemplary computer system.

### DETAILED DESCRIPTION

Embodiments of the present disclosure may provide a system and method for providing aggregated data to a client from a plurality of data sources. The method may include maintaining data in a data repository, maintaining a first analytical view having a first set of metadata including a first set of attributes, and maintaining a second analytical view having a second set of metadata including a second set of attributes. The method may include receiving a request for information, the request specifying the first analytical view and the second analytical view. The information from the data repository in accordance with the first set of metadata and the second set of metadata may be extracted and the extracted information may be analyzed to generate aggregated data in accordance with the first set of metadata and the second set of metadata. The aggregated data may be provided to the client.

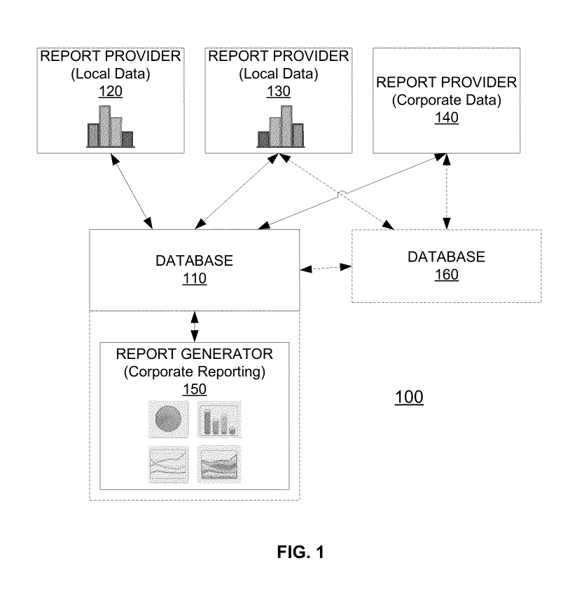

FIG. 1 is a block diagram of an exemplary database system 100. The system 100 may include a database 110 and report providers 120, 130 and 140, and a report generator 150. The report generator 150 may be part of the database 110. The report providers 120, 130, 140, database 110 and report generator 150 may be used as networked applications used to generate a report or analytics based on real time data.

The report generator 150 may create new reports using the data in database 110 or the reports provided by the report providers 120, 130 or 140. The report providers 120, 130 or 140 may use the report from the report providers 120, 130 or 140 or the data in the database 110 to create new reports. The reports provided by the report providers 120, 130 and 140 may be based on analytical views. Thus, the report providers may provide analytical views to the database 110. The report generator 150 may use these analytical views to create new reports or analytical views. The new analytical views can be created by combining existing views using functions such as union or join functions.

Report providers 120, 130 and 140 may provide analytical data to the database 110 and/or report generator 150. The data may include local reports or corporate data. Local reports may be generated by subsidiaries of a corporation and may include regional or specialized reports. Corporate data may include data relating to operations of the corporation and may include information that is not available to or cannot be provided by the report providers 120 and 130. Report providers 120, 130 or 140 may include an on-demand enterprise resource planning and management software (e.g., ByDesign by SAP AG, but is not so limited) to provide reports and/or analytical views.

Users (e.g., subsidiaries) associated with the report providers 120, 130 or 140 may use the report providers to generate local reports. The local reports generated by report providers 120, 130 or 140 may also be provided to other users (e.g., corporation) by giving access to the reports and/or data used for the reports. The reports, information about the reports and/or data used for the reports may be stored in the database 110 (e.g., central analytical data provisioning system). The local reports can be provided to a database 110 automatically or when the report is requested by a user using the report generator 150. The information about the report may be used to find the source (e.g., report provider 120, 130 or 140) of the report and/or data used in the report if a new report needs that information.

The report in the report providers 120, 130 or 140 may be generated automatically when certain data is collected or entered, at predetermined intervals (e.g., monthly, weekly or daily) or at the occurrence of certain event (e.g., predetermined number of product sold). The report in the report providers 120, 130 or 140 may also be generated manually by a request of a user of the report provider 120, 130 or 140 or a user of the database 110 or report generator 150. The report generated by the report provider 120, 130 or 140 or a notification that the report is available may be delivered to the database 110 when the report is generated, at predetermined intervals, or at the occurrence of certain events. The data for the report may be extracted from the report provider 120, 130 or 140 by a request from the database 110 or the report generator 150. In a system using a ByDesign reporting, the data may be pulled out of ByDesign via an extraction scheduled in the database 110.

The reports may be created by report providers 120, 130, 140 or 150. The report providers 120, 130 or 140 may use data stored in the report providers 120, 130 or 140 or the data in the database 110 to create the reports. The data used for the reports by report providers 120, 130 or 140 may also be stored in a storage device (not shown in FIG. 1) associated with each of the report providers 120, 130 or 140.

The report generator 150 may use the data in the database 110 to create a new report. The report generator 150 may use the reports provided by the report providers 120, 130 or 140 to create the new report. The report generator 150 may combine, for example by using union and/or join functions, the reports to create a new report. The generation of a new report may use the association between multiple analytical views. For example, attributes of an analytical view can be extracted from one analytical view and included in another analytical view. Thus, new fields can be added to analytical views or fields can be updated with data from other views. The analytical views can be used to display the available analytical data and allow a user to select what data to use in the new report. The new report may be filtered to limit the scope of the report.

By using the reports generated by the report providers 120, 130 or 140, the report generator 150 may not need to search for the data it needs for the report in the database 110 or in other databases that provide data to the report providers 120, 130 or 140 (e.g., databases associated with each of the report providers 120, 130 or 140). In addition to using the reports provided by the report providers 120, 130 or 140, the report generator 150 may use the additional data in database 110 to create the report. The report generator 150 may use data or instructions from external applications to create the report.

The database 110 may be configured to perform modeling of data, data mapping, integration, data retrieval from source systems (e.g., from a report provider 120), data transformation, data consolidation, data cleanup, data retrieval for analysis and interpretation, process management and data warehouse management. The database 110 may include a metadata depository. The database 110 may be a SAP AG HANA database. The database may be a business information warehouse, such as SAP AG Business Information Warehouse, but is not so limited. The business information warehouse may perform data administration and modeling, manage metadata and manage business content. The database 110 may manage data exchange between sources of data (e.g., report providers or subsidiaries) and applications requesting analytical data (e.g., a corporation or users placing request to the report generator or database).

Reports provided by report providers 120, 130 or 140 and created by report generator 150 may include analytical reports. Analytical reports may be based on analytical views of business object data. The analytical views may be provided by an on demand system (e.g., ByDesign by SAP AG, but is not so limited). The analytical views may be used to create the report by the report generator 150. The report generator 150 may use the analytical views from the report providers 120, 130 or 140 to create new analytical views. The new analytical views can be created by combining existing analytical views using various functions such as union and/or join functions, but is not so limited. The union function may include deleting a redundancy in the combination and the join function may append the information from one analytical view to another analytical view.

In one embodiment the data of the report from the report generator 120, 130 or 140 may be replicated in the database 110. For example, the data may be replicated from the ByDesign system. The data may be stored as analytical models (e.g., central analytical models) in the database 110. The data in the database 110 may be replicated by fully loading the data or the data can be loaded by an initial load followed by subsequent delta requests.

Alternatively, the data can be accessed directly without replication. Thus, the data for the report generator 150 may be accessed directly in real time. For example, the database 110 and the report generator 150 may access the analytical view directly without replication, to have the real time information in the new report.

The reports may include aggregation. Aggregation can include the combination or compression of various data, measured values, or indicators to superordinate key figures using certain rules (aggregation rules). Aggregation may be used for a spatially, temporally, or factually compressed display. Aggregation may reduce the memory requirements of the database 110.

Reports may be based on analytical views provided by the report generators 120, 130 or 140 because there is no separate data replication required for analytics. For example, ByDesign by SAP AG analytical views may use TREX or HANA DB indices. These indices allow for very high performance of databases using these analytical views.

The analytical views may be used to extract data for a new report. The analytical views may be used to extract data of the analytical view instead of the report using the analytical views, when the report includes aggregation. The report may include aggregation when the report is generated on top of an analytical view. Errors to the data may be introduced if a report already having aggregation is used to generate the new report which will also have aggregation. The errors may be introduced because aggregation (e.g., average aggregation of a key figure) is generated on top of aggregation.

As discussed above, a new analytical view may be created by combining existing analytical views. The existing views may be provided by the report providers 120, 130 or 140, to the database 110. The existing view may be stored in the database 110. The database 110 may also include existing analytical views that were combined by the database 110 or the report generator 150. ByDesign may be used to create the analytical views and to combine existing views. Because existing views can be used for a new view, content created by the report providers 120, 130 or 140 or the report generator 150 can be reused. New content may be created by creating the new analytical view and the new content can be extracted from the analytical view.

Mapping information can be added to the analytical views. Data from report provider 140 or data from database 110 may be used for the mapping. The mapping information may map data provided by the data providers 120, 130 and 140 to the data in database 110 and data that may be used by the report generator 150. For example, the features of the analytical view created in ByDesign can be mapped to the features of the database (e.g., global ID of the corporate system).

The database 100 may further include a second database 160. The second database 160 may receive analytical reports from one or more of the report providers (e.g., report providers 130 or 140). The database 160 may be used to create reports using the analytical reports provided from the report providers. The database 160 may also be coupled to the database 110 to exchange reports between the second database 160 and database 110.

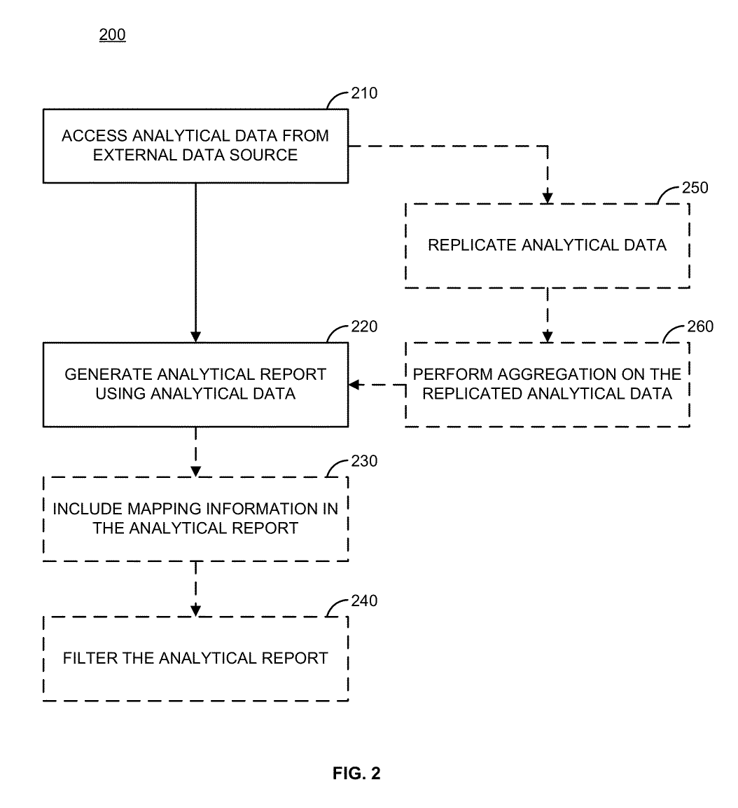

FIG. 2 shows a method 200 for accessing analytical data across networked applications to create a report. The method 200 may include accessing analytical data from external sources 210 (e.g., report providers 120, 130 or 140) and generating an analytical report using analytical data 220. The method may be executed by a processor (e.g., processor in database 110 and/or report generator 150). The method may be executed by a processor in response to instructions, with the instructions embodied in a machine-readable medium.

Accessing the analytical data from the external sources 210 may include accessing analytical models and/or analytical views from the external sources. The external sources may use the analytical models or analytical views to provide reports for local reporting or to provide reports to a central database (e.g., database 110 in FIG. 1). The analytical data may include multi dimensional analytical views. The analytical models and/or analytical views may be modified by the user at the external source. The external source may provide standard reports or customized reports using the models or views.

The analytical data for the new analytical report may be accessed directly from the external sources. Thus, no replication of the data is required in the database and the analytical view can be accessed on the fly to have real time information from the external sources. Accessing the analytical data from the external sources 210 may include requesting available reports for data extraction from the external sources 210. The database may receive a list of the available reports and provide details for the reports. A user can select which reports or portions of the reports can be used for a new report or can be replicated in the database.

The models or views from the external sources can be used to expose the analytical data that can be used to generate a new analytical report 220. The new analytical report may be generated using analytical data provided from one or more external sources. The new analytical report may be generated by combining the analytical data provided by the external sources (e.g., generate a new analytical view using the one or more analytical views provided by the external sources). The new analytical views can be created by combining existing views using functions such as union or join functions.

The method 200 may include mapping information in the generated report 230. The generated report may be generated using the data from the external sources. The mapping may include adding information to the analytical views such that information from the external sources can be mapped to the information in the database. The data for the mapping may be provided by the external sources that provide the data for the report, by other external sources storing the mapping information, by the database being used to generate the new report or by a storage device dedicated to store the mapping information.

The method 200 may include filtering the analytical report 240. The filtering may be performed on the data provided in the report or the data to be used in the report. The filtering may include selecting a subset of the data to be generated in the report (e.g., data for the last month or data for a certain product line). The filtering may be performed when the amount of data used for the report exceeds a predetermined amount. The filtering may be performed at the time the analytical data is accessed.

The method 200 may include replicating the analytical data 250. The replication of the analytical data from the external sources may be performed in the database. The data that is replicated can be data that is used in the reports provided by the external sources. The replication may be performed on the data from the analytical views used in the external applications. The data that is replicated can be used to generate the new analytical report 220. replicating the analytical data 250 may include determining whether replication of the data is allowed. The determination may include comparing a flag set in the multi dimensional analytical view indicating whether the data can be replicated.

The method 200 may include aggregating the analytical data 260. Aggregation may be performed on analytical data that is received from one or more external sources and/or the analytical data stored in the database. The aggregation may be performed on the report that is generated using the analytical data (e.g., generated in step 220). Aggregation may include combination or compression of the analytical data (e.g., measured values or indicators to superordinate key figures using aggregation rules). Aggregation may be used to reduce the memory requirements of the database. The analytical data that has been aggregated may be used to generate the report 220.

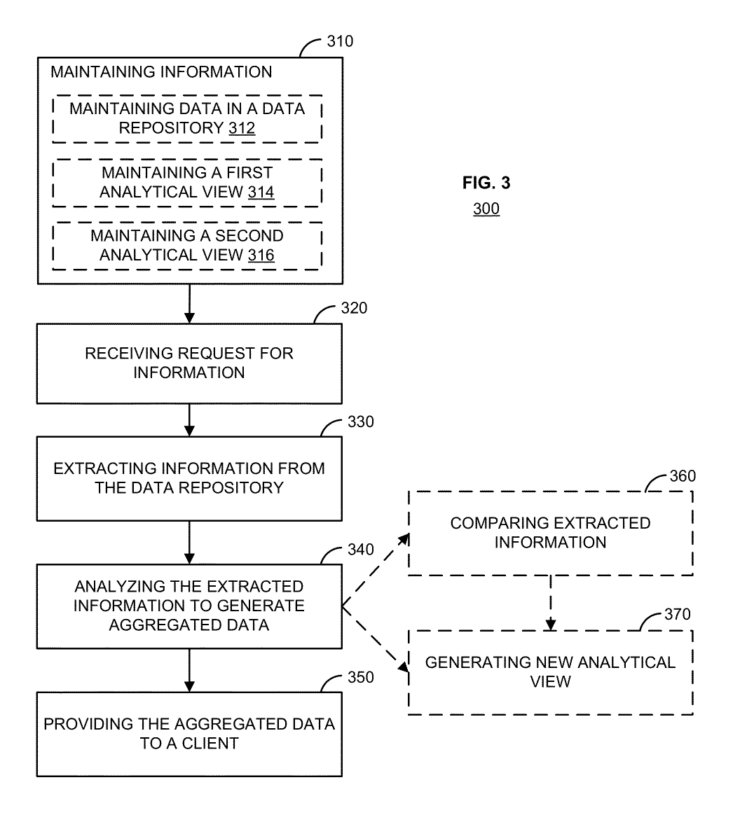

FIG. 3 illustrates another embodiment of a method 300 for accessing analytical data in a database. The method may be executed by a processor (e.g., processor in database 110 and/or report generator 150). The method may be executed by a processor in response to instructions, with the instructions embodied in a machine-readable medium. The method 300 may include maintaining information 310, receiving request for information 320, extracting information from the data repository 330, analyzing the extracted information to generate aggregated data 340, and providing the aggregated data to a client 350.

Maintaining information 310 may include maintaining data in one or more data repositories and maintaining data for a plurality of analytical views. Maintaining information 310 may include maintaining data in a data repository 312, maintaining a first analytical view 314, and maintaining a second analytical view 316. The first analytical view and the second analytical view may be maintained by one of a plurality of data repositories and/or a data source (e.g., report providers).

The data in the data repository may be data from a plurality of data sources (e.g., report providers and report generators). The data may include local reports or corporate data. The first analytical view may have a first set of metadata and the first set of metadata may include a first set of attributes. The second analytical view may have a second set of metadata and the second set of metadata may include a second set of attributes. One or more of the metadata sets (e.g., the first set of metadata or the second set of metadata) may include information specifying how to generate the aggregated data set.

The metadata (e.g., first set of metadata) may include information identifying an access mode. The access mode may be associated with a user, a report provider or a report generator. The access mode may be one of direct access or replication. The direct access to information may be access in real time and without replication. The direct access may include real time access and/or ability to manipulate the information stored in the data repository. Replication may be access to copy the data from the one or more of the data repositories and/or data sources. The access mode may include a level of access for each of the available data repositories and/or data sources. The metadata may provide an access mode for each available data repository and/or data source and each data repository and/or data source may have a different level of access.

The set of attributes in the first set of metadata may be different from the set of attributes in the second set of metadata. Some of the attributes in the first set of metadata and the second set of metadata may be the same. The first set of metadata may include at least one attribute that is different than the attributes in the second set of attributes associated with the second set of metadata, A set of attributes for one analytical view may include one or more attributes identifying other analytical views. For example, the first set of attributes may include an attribute identifying the second analytical view.

Receiving a request for information 320, may include a request specifying one or more analytical views. The request may specify the first analytical view and the second analytical view. The request may be processed by one of the report providers and/or one of the report generators.

Extracting the information from the data repository 330 may be performed in accordance with the metadata of the one or more analytical views specified in the request. For example, the extracting of the information may be performed in accordance with the first set of metadata of the first analytical view and the second set of metadata of the second analytical view. The data repository may access the data associated with the request from the one or more data sources. Extracting the information from the data repository may include identifying the information from the data repository based on the first set of attributes associated with the first analytical view and the second set of attributes associated with the second analytical view and replicating the information in the data repository. In another embodiment, the information may be retrieved directly from the data repository and/or the data source. Extracting the information may include using at least one of union and join functions.

Analyzing the extracted information to generate aggregated data 340 may be performed in accordance with the first set of metadata and the second set of metadata. The analyzing may include comparing the metadata and/or the attributes of the analytical views (e.g., the first and second analytical views). Analyzing the extracted information may include comparing the data provided by each of the analytical views.

The aggregated data may be provided to a client 350 after the extracted information is analyzed and aggregated data is generated. The aggregated data may be provided to a client by sending a notification that the aggregated data is available, by providing the aggregated data to the client (e.g., at a storage device associated with the client) or by providing access to the aggregated data that is stored in one of the data repositories. The aggregated data may be used to create a new report based on association between multiple analytical views. The new report may be filtered to limit the scope of the report (e.g., data for the last month or data for a certain product line). The filtering may be performed when the amount of data used for the report exceeds a predetermined amount.

The method 300 may further include, identifying a second repository based on information in the one or more of the sets of metadata and retrieving the information from the second repository in accordance with the metadata. The second repository may be identified if the information in the set of metadata (e.g., first set of metadata) includes information associated with the second repository. This information may not be available in the original repository (e.g., first repository) or may be more up to date in the second repository. The second repository may be associated with one of the data sources (e.g., second repository may maintain one of the analytical views).

The method 300 may include, generating a new analytical view 370. The new analytical view may be generated based on one or more of the sets of metadata (e.g., the first set of metadata and the second set of metadata). The new analytical view may be generated after the information is extracted from the repository. The new analytical view may be generated by updating one of the existing analytical views (e.g., the first analytical view or the second analytical view) or by creating a separate new analytical view (e.g., a third analytical view).

The new analytical view may be generated in response to a comparison of the extracted information 360. The comparison of the extracted information 360 may be information extracted in accordance with the first set of metadata and the information extracted in accordance with the second set of metadata. The new analytical view may be generated based on the difference found in the comparison. The new analytical view may include metadata with a set of attributes included in one of the existing analytical views but not included in the other one of the existing analytical views. The new analytical view may be stored in the data repository, used to generate a report, provided to the user or used to provide aggregated data to the user.

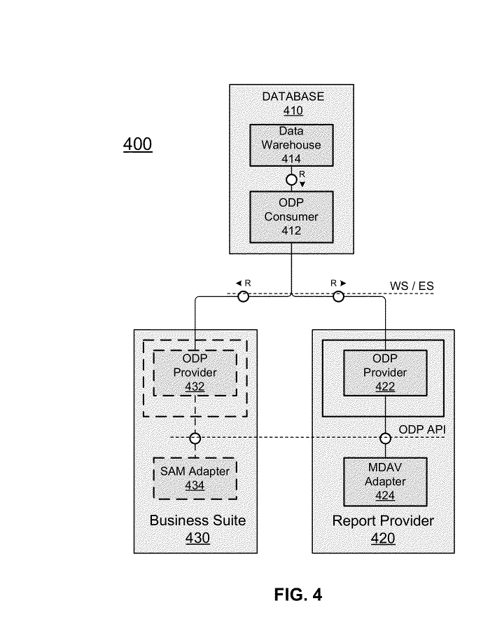

FIG. 4 illustrates system 400 coupling a report provider to a database. The system may include a database 410, report provider 420 and business suite 430. The system 400 may include networked solutions for performing analytics on the different levels of the system. The networked solutions may include lightweight analytics, advanced analytics and extraction. The lightweight analytics may include local analytical queries and actions by the report provider 420. The advanced analytics may include analytical tools for advanced functions and harmonized usability of the report provider 420. Extraction may include accessing the analytical data of the applications of the report provider 420 to provide the data to other applications or across multiple applications, such as applications in the database 410.

The report provider 420, which may be a business management software (e.g., ByDesign by SAP AG, but is not so limited), can be used to generate or provide reports to the database 410. The database 410 may be a central data warehouse. The database 410 may include data warehouse 414 coupled to an operational data provider (ODP) consumer 412 to store the data. The database 410 may include an ODP consumer 412 which accesses and/or receives the data from the report provider 420 or the business suite 430.

The report provider 420 may include an ODP 422 and multi dimensional analytical view (MDAV) adapter 424. The ODP 422 and ODP consumer 412 can be used as a standard application programming interface to provide direct access or replicate the reports (e.g., analytical views).

The ODP 422 may include a unique identifier, metadata describing the structure, semantic and relevant analytical properties of the underlying view, and services for accessing view data. The ODP 422 may define a set of interfaces for data that is classified as transaction data or master data (attributes, texts, or hierarchies). The interfaces may enable the access to data for reporting/analytics purposes as well as for mass data replication. The ODP may represent the analytical view provided by report provider 420 and visible to other applications (e.g., database 410). In ByDesign, the ODP may represent the MDAVs and additional constraints referenced by the MDAVs (e.g., code lists and hierarchies).

The data from the report provider 420 may be exposed at the MDAV level utilizing MDAV adapter 424. The MDAV levels may have restrictions as to which MDAV level can used to provide the data to the database 410. For example, a flag can be set on the MDAV level to provide whether the DMAV level can be used to expose the data for the new report or analytical view.

The business suite 430 may be a set of business software having functions to support business processes within a business (e.g., corporation) and organizations outside of the business (e.g., other corporations or other industries). The business suite may include an ODP provider 432 and a Search and Analytics Model (SAM) adapter 434. The SAM adapter may allow a common access for search and analytics to data in the business suite.

The ODP provider 422 may communicate with ODP consumer 412 in the database 410. The ODP provider 422 and the ODP consumer 412 may include an application programming interface for direct access and replication of reports or analytical views. The application programming interface of the ODP provider 422 and the ODP consumer 412 may define web services for communication.

The ODP provider 422 and the MDAV adapter 424 in the report provider 420 may use the metadata for the report. The ODP metadata may include header data describing overall properties of the ODP, field data describing properties of each field in the ODP structure, association data describing links from one ODP to another ODP (e.g., a transactional MDAV to one or more master data MDAVs or from a master data MDAV to related texts). The database 410, using the ODP consumer 412, may provide the same or similar data structures in the applications making the requests with the database 410. The database 410 may provide a single access channel for each report provider 420 that can be used to provide data to the database 410. Thus, the database may provide the new reports, models or analytical views using the data from a plurality of report providers 420, that cannot be provided by the report provider 420 on its own.

When the amount of data to be provided to the database 410 exceeds a predetermined amount, a safety belt may be implemented to prevent the extraction of a very high volume of data. The safety belt may limit the amount of memory used for transferring the data. The safety belt may limit the number of cells that may be transferred.

The report provider 420 may provide analytical data to the database that includes one or more elements of field ID, technical data type (e.g., specification of value restrictions and conversion), visibility to consumers, selection properties, supported options, analytical properties (e.g., characteristics, key figures and/or navigation attributes), relevance for instance authorization, language-dependent field names and ODP field semantics. These elements may be elements of the ODP field. The ODP field semantics may be included as an additional property maintained for each ODP field.

The semantics may be used to identify fields in different report providers 420 (e.g., different ODPs) and to assign the same text labels, and/or common handling of field data. The common handling of field data can be used to describe the same business information and process in the database 410 provided from different report providers 420. The report providers 420 may have different field names because the MDAV's of different report providers 420 may provide their own field names.

The data extraction from the report providers 420 may be performed when the database 410 requests the data or the report. The request may be processed by an extraction, transformation and loading adapter in the report provider 420.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

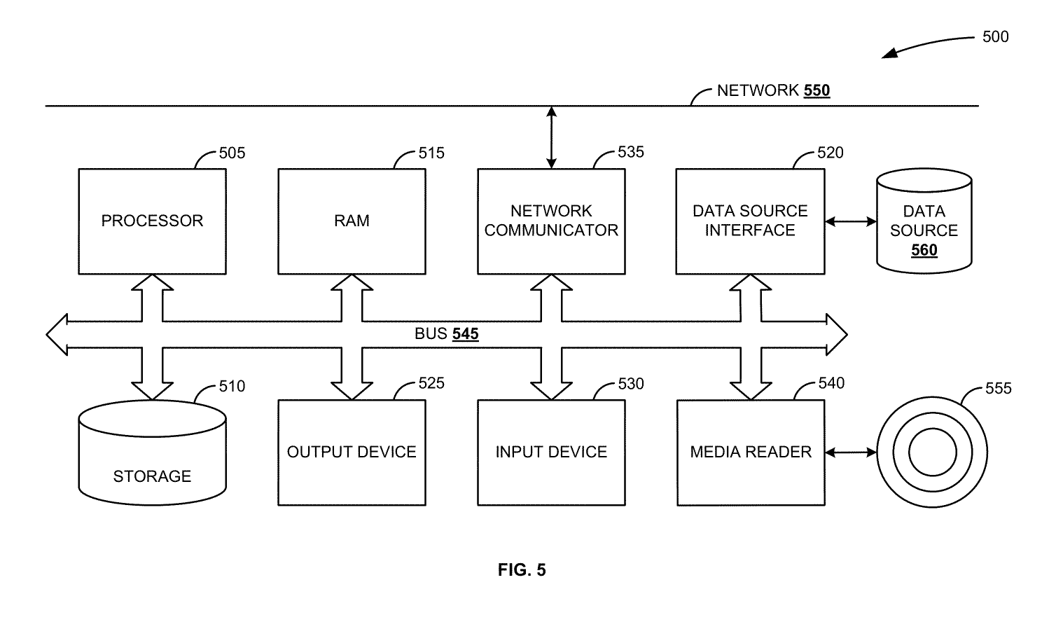

FIG. 5 is a block diagram of an exemplary computer system 500. The computer system 500 includes a processor 505 that executes software instructions or code stored on a computer readable storage medium 555 to perform the above-illustrated methods. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

In the above description, numerous specific details are set forth to provide a thorough understanding of embodiments of the disclosure. One skilled in the relevant art will recognize, however that the embodiments can be practiced without one or more of the specific details or with other methods, components, techniques, etc. In other instances, well-known operations or structures are not shown or described in details to avoid obscuring aspects of the disclosure.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the disclosure to the precise forms disclosed. While specific embodiments of, and examples for, the disclosure are described herein for illustrative purposes, various equivalent modifications are possible within the scope of the disclosure, as those skilled in the relevant art will recognize. These modifications can be made to the embodiments in light of the above detailed description. Rather, the scope of the embodiments is to be determined by the following claims, which are to be interpreted in accordance with established doctrines of claim construction.

We claim:

1. A method comprising:
maintaining data in a data repository, wherein the data is from a plurality of data sources;
maintaining a first analytical view having a first set of metadata, the first set of metadata including a first set of attributes;
maintaining a second analytical view having a second set of metadata, the second set of metadata including a second set of attributes;
receiving a request for information, the request specifying the first analytical view and the second analytical view;
extracting the information from the data repository in accordance with the first set of metadata of the first analytical view and the second set of metadata of the second analytical view;
analyzing the extracted information to generate aggregated data in accordance with the first set of metadata and the second set of metadata; and
providing the aggregated data to a client.

2. The method of claim 1, wherein the extracting comprises:
identifying the information from the data repository based on the first set of attributes and the second set of attributes; and
replicating the information from the data repository.

3. The method of claim 1, wherein the extracting comprises:
identifying the information from the data repository based on the first set of attributes and the second set of attributes; and
retrieving the information directly from the data repository.

4. The method of claim 2, wherein first set of attributes includes an attribute identifying the second analytical view.

5. The method of claim 1, wherein the first set of metadata includes at least one attribute different than attributes in the second set of attributes.

6. The method of claim 1, wherein the first set of metadata includes information specifying how to generate the aggregated data set.

7. The method of claim 1, further comprising:
identifying a second repository based on information in the first set of metadata; and
retrieving information from the second repository in accordance with the first set of metadata.

8. The method of claim 1, wherein extracting the information includes using at least one of union and join functions.

9. The method of claim 1, further comprising generating a new analytical view based on the first set of metadata and the second set of metadata.

10. The method of claim 1, wherein the first set of metadata includes information identifying an access mode, wherein the access mode is one of direct access or replication.

11. The method of claim 1, further comprising:
comparing information extracted in accordance with the first set of metadata and information extracted in accordance with the second set of metadata;
generating an analytical view based on difference found in the comparison.

12. A non-transitory computer readable storage medium storing one or more programs configured to be executed by a processor, the one or more programs comprising instructions for:
maintaining data in a data repository, wherein the data is from a plurality of data sources;
maintaining a first analytical view having a first set of metadata, the first set of metadata including a first set of attributes;
maintaining a second analytical view having a second set of metadata, the second set of metadata including a second set of attributes;
receiving a request for information, the request specifying the first analytical view and the second analytical view;
extracting the information from the data repository in accordance with the first set of metadata of the first analytical view and the second set of metadata of the second analytical view;
analyzing the extracted information to generate aggregated data in accordance with the first set of metadata and the second set of metadata; and
providing the aggregated data to a client.

13. The computer readable storage medium of claim 12, wherein the extracting comprises:
identifying the information from the data repository based on the first set of attributes and the second set of attributes; and
replicating the information from the data repository.

14. The computer readable storage medium of claim 12, wherein the extracting comprises:
identifying the information from the data repository based on the first set of attributes and the second set of attributes; and
retrieving the information directly from the data repository.

15. The computer readable storage medium of claim 13, wherein first set of attributes includes an attribute identifying the second analytical view.

16. The computer readable storage medium of claim 12, wherein the first set of metadata includes at least one attribute different than attributes in the second set of attributes.

17. The computer readable storage medium of claim 12, wherein the first set of metadata includes information specifying how to generate the aggregated data set.

18. The computer readable storage medium of claim 12, wherein extracting the information includes using at least one of union and join functions.

19. The computer readable storage medium of claim 12, wherein the first set of metadata includes information identifying an access mode, wherein the access mode is one of direct access or replication.

20. A system, comprising:
one or more processors; and
memory storing one or more programs for execution by the one or more processors, the one or more programs including instructions for:
maintaining data in a data repository, wherein the data is from a plurality of data sources;
maintaining a first analytical view having a first set of metadata, the first set of metadata including a first set of attributes;
maintaining a second analytical view having a second set of metadata, the second set of metadata including a second set of attributes;
receiving a request for information, the request specifying the first analytical view and the second analytical view;
extracting the information from the data repository in accordance with the first set of metadata of the first analytical view and the second set of metadata of the second analytical view;
analyzing the extracted information to generate aggregated data in accordance with the first set of metadata and the second set of metadata; and
providing the aggregated data to a client.
